(19) United States
(12) Patent Application Publication
(10) Pub. No.: US 2011/0314331 A1
(43) Pub. Date: Dec. 22, 2011

(54) AUTOMATED TEST AND REPAIR METHOD AND APPARATUS APPLICABLE TO COMPLEX, DISTRIBUTED SYSTEMS

(75) Inventors: Glenn J. Beach, Grass Lake, MI (US); Kevin Tang, Ann Arbor, MI (US); Chris C. Lomont, Ann Arbor, MI (US); Ryan O'Grady, Ann Arbor, MI (US); Gary Moody, Dexter, MI (US); Eugene Foulk, Ann Arbor, MI (US); Charles J. Jacobus, Ann Arbor, MI (US)

(73) Assignee: Cybernet Systems Corporation, Ann Arbor, MI (US)

(21) Appl. No.: 12/915,160

(22) Filed: Oct. 29, 2010

Related U.S. Application Data
(60) Provisional application No. 61/255,929, filed on Oct. 29, 2009.

(51) Int. Cl. G06F 11/07

(52) U.S. Cl. 714/26; 714/E11.029

(57) ABSTRACT

An intelligent system for automatically monitoring, diagnosing, and repairing complex hardware and software systems is presented. A number of functional modules enable the system to collect relevant data from both hardware and software components, analyze the incoming data to detect faults, further monitor sensor data and historical knowledge to predict potential faults, determine an appropriate response to fix the faults, and finally automatically repair the faults when appropriate. The system leverages both software and hardware modules to interact with the complex system being monitored. Additionally, the lessons learned on one system can be applied to better understand events occurring on the same or similar systems.

### REFERENCE TO RELATED APPLICATION

This application claims priority from U.S. Provisional Patent Application Ser. No. 61/255,929, filed Oct. 29, 2009, the entire content of which is incorporated herein by reference.

### GOVERNMENT SUPPORT

This invention was made with Government support under Contract N65538-08-M-0162 awarded by U.S. Navy Sea Systems Command. The Government has certain rights in the invention.

### FIELD OF THE INVENTION

This invention relates generally to automated electronic system maintenance and, in particular, to an automated test and repair system and method applicable to complex, distributed systems.

### BACKGROUND OF THE INVENTION

The growing complexity of distributed systems has limited the capability to test and repair software and hardware under a wide range of fault scenarios. The rapid deployment of networked systems has not yet led to an equally advanced plan for the maintenance community to identify and perform preventative maintenance on these systems. While some current and planned distributed systems include automated monitoring and reporting capabilities for system health, there is currently no capability to automatically predict failures and prevent them before they occur. Additionally, the complexity of these networked systems has increased to a point where it is difficult for a single technician to truly understand and debug them. As a result, the potential for mission failure due to system faults has risen to an unsatisfactory level.

As vehicles have become more complex and more expensive, researchers have begun to investigate the use of condition-based maintenance and prognostic maintenance to improve overall reliability and performance while reducing lifecycle costs associated with their operation. Commercial automotive manufacturers have started to incorporate this functionality in consumer grade vehicles to catch potential problems before they cause significant damage (such as engine monitors, oil life monitors, and others). Additionally, they have incorporated systems to increase the overall safety of the vehicles (such as tire pressure monitors).

With the high cost of military vehicles and their long operational lifetime, the defense industry has also started to integrate both condition based and prognostic maintenance systems into today's military vehicles. Much like the commercial systems, the systems in military vehicles are designed to increase the overall reliability the vehicles while driving down ownership costs. However, these systems tend to be more comprehensive and are frequently designed to work across vehicle fleets to help reduce the fleet ownership costs while improving overall vehicle availability across the fleet.

While these maintenance systems are beginning to show favorable results, they have been constrained to relatively simple vehicle systems composed of mechanical and electronic components (such as engine monitors, temperature sensors, and the like). These systems are not directly applicable to larger more complex systems that leverage sophisticated computer networks along with hardware systems to perform missions, such as factories, submarines, large ships, and other complex systems. In this case, a mission is defined as a specific task with which a person or system/facility is charged to complete. In many cases, these complex systems cannot go down without causing significant damage or incurring significant cost. For example, the command and control system on a submarine must remain operational or the submarine may become lost at sea. For these types of complicated systems, any automated maintenance system must be capable of making decisions about what systems can be sacrificed to ensure that mission critical systems are always functional.

The level of decision making demanded in today's complex systems requires a more comprehensive view of overall system interactions and cost metrics associated with determining how system components can be leveraged to maintain all mission critical functions.

### SUMMARY OF THE INVENTION

This invention resides in an Automated System Test and Repair (“A-STAR”) system and method to automatically detect and predict system faults and automate repair actions in complex, distributed target systems with minimal input from human maintainers.

The A-STAR system is able to detect both hardware and software faults within a target system, repair faults with minimal crew intervention, and take proactive steps to prevent potential future failures. The system includes a learning capability, such that over time it is able to discover interdependencies and trends within the target system. While the A-STAR allows operators to enter information about system configuration, the learning capability enables A-STAR to build a layout of these complex systems without requiring lengthy user input. The system provides tools to learn and understand the overall interrelationships of target system components to construct a complete and comprehensive understanding of the system being maintained over time. This knowledge is developed by monitoring incoming data to detect how changes in components lead to changes in other components.

The A-STAR system includes a knowledge base memory storing information about the target system, including information about the network topology of the target system, system events and system faults, and one or more computer processors including specialized hardware and software implementing a system status module, a decision module, and a user interface module, all modules being in operative communication with the knowledge base memory.

A communications interface between the target system and system status module enables the system status module to detect faults in the target system, determine the underlying cause or causes of a fault, and predict potential future faults in the target system based upon information stored in the knowledge base memory. The decision module is in operative communication with the system status module, enabling the decision module to identify an appropriate response to a fault detected by the system status module, the response potentially including an automated repair of the fault depending upon the severity of the fault. A user interface module, in operative communication with the decision module, includes a display presenting repair actions taken by the decision module.

The user interface module may further include a repair action module enabling a user to input feedback regarding actions undertaken to test and repair the target system. Decisions made by the decision module may be based on the current mission state of the target system, and may be based on cost factors including likelihood of success and mission impact.

Repair actions may either be automatically performed or reported to a user for final decision and action. Repair actions are also communicated to the knowledge base memory and stored for use in predicting future repair actions associated with the target system. A plurality of format converters are operative to convert data into formats appropriate to the system status module, decision module, and user interface module.

### BRIEF DESCRIPTION OF THE DRAWINGS

FIG. 1 is an overview of components and interactions associated with a preferred embodiment of the invention.

### DETAILED DESCRIPTION OF THE INVENTION

In broad and general terms, the system and method of this invention, called A-STAR herein, is designed to ensure that mission critical faults do not occur and if they do occur, appropriate action is taken to reconfigure system functionality and apply resources from non-mission critical tasks to mission critical functions. The following definitions apply to this disclosure:

A target system is a set of components that work together to provide a capability to end users or other systems. These components can be hardware, software, or combinations of the two. Hardware can include both computer components as well as physical components such as temperature sensors, cameras, valves, switches, etc.

A system fault is as any event that causes the system to be unable to deliver its required capabilities in the required timeframe. These faults are divided into mission critical faults and non-mission critical faults.

A mission-critical fault implies that the system cannot continue to function while the fault is occurring.

A non-mission-critical fault occurs when a subsystem has an error, but the overall system can continue to deliver required capabilities, but potentially at a reduced performance level.

A large amount of manpower is required to fully develop the expert knowledge of a complex distributed system needed to develop automated tools for fault detection and repair. Therefore, the A-STAR system includes an intelligent self-learning capability to discover the cause-and-effect behavior of components within the system. This self-learning capability enables the system to perform predictive maintenance under unknown circumstances where a priori knowledge of the overall system configuration did not exist or was no longer current.

The A-STAR system provides at least the following capabilities:

1. Detection of system faults

2. Determination of root cause of faults

3. Determination of fault precursors (conditions that are likely to lead to a fault)

4. Prediction of impending faults

5. Identification of actions for resolving or preventing faults

6. Prioritization of repair actions based on system impact and operational cost

7. Reporting of detected or predicted faults to system maintainer

8. Automated execution of repair actions

9. Generation of system design metrics based on the accumulated knowledge base

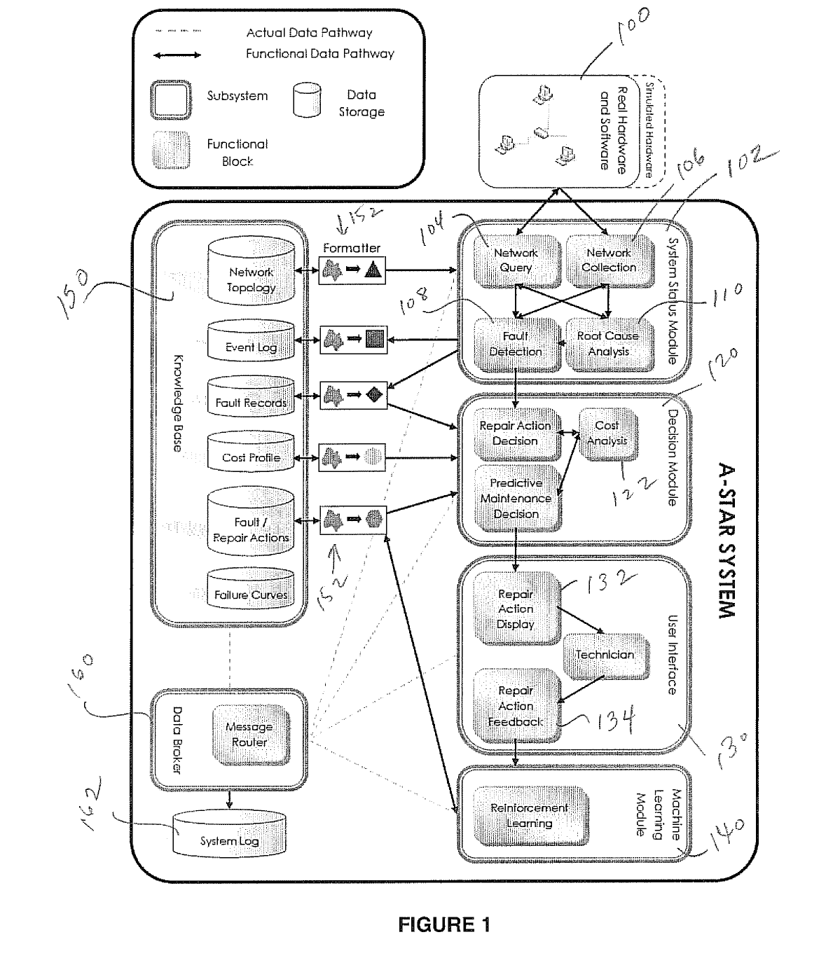

Reference will now be made to FIG. 1, which presents an overview of components and interactions associated with a preferred embodiment of the invention. The target system 100 includes real hardware and software and well as, in some cases, simulated hardware. The System Status Module 102 receives data from the hardware and software within the target system 100 through Network Query and Network Collection blocks 104, 106 and performs active queries on the hardware and software within the system. The System Status Module 102 then uses collected information, along with information from the Knowledge Base 150 to estimate the current state of the system.

The Knowledge Base 150 is a centralized data repository that provides generic data storage and multiple data formatters 152 to present data in a manner suitable to individual modules. The Data Broker 160 is a central data router that allows decoupled communication between the modules of the A-STAR system, and maintains a System Log 162.

The System Status Module 102 includes multiple subsystems, including a Fault Detection module 108 to detect existing faults and predict impending faults. A Root Cause module 110 determines the root cause of faults, as opposed to merely the symptoms caused by a particular fault.

The Decision Module 120 chooses one or more potential repair or preventative action based on detected or predicted faults identified by the System Status Module 102. A cost analysis decision made by module 122 is based on the current operational parameters of the system. Operational parameters define the importance of particular functionality and subsystems within the target system. Other modules include a Repair Action Decision block 124 and a Predictive Maintenance Decision block 126. Overall, the Decision Module 120 uses an artificial intelligence approach that leverages the overall likelihood of repair success (based on historical and expert knowledge), including the mission impact of the repair (for example, whether or not any mission critical systems need to be taken down in order to perform the repair), and any other available information which might prove useful.

The User Interface Module 130 generates performance and repair reports based on the events logged and performed by the A-STAR system. The reports include the types of errors found, the potential severity of those errors if they had not been detected, and expected conditions under which those errors will have been generated during mission critical system operations. This reporting module also generates metrics based on the past performance of similar configurations to provide design feedback for future submarine systems. A technician is able to view a Repair Action Display 132 and provide Repair Action Feedback at 134 about the results of specific repair actions. These results are then fed back into the Knowledge Base 150 to improve future results.

The User Interface module 130 is also one way for the system maintainer to interact with the A-STAR system. The user interface also displays system information through Repair Action Display 132, such as network connections, available resources, etc. The maintainer can also enter supplementary information. This information can include topology information such as the number of servers and sensors and their connections relative to each other. The User Interface also displays the current status of the A-STAR system and the distributed hardware and software resources monitored by background processes.

In the Machine Learning module 140, the A-STAR system continuously mines the system data for trends that can be incorporated into the knowledge of the target system 100. Historical data from the Knowledge Base 150 and other similar systems enables the Machine Learning module 140 to correlate results and learn the critical trends that led to repair actions. This module also takes feedback from the user in order to evolve the behavior of the system over time.

The A-STAR system provides several modes of operation for the Maintainer: Detection, Detection & Fix, and Detection & Predictive Maintenance.

### Detection Mode of Operation

In Detection Mode, the system alerts the user when a problem has been detected and presents a set of repair actions to resolve the problem. These actions link directly to the appropriate maintenance instructions for how to repair the fault. The system detects problems which may not be obvious to detect, based on its sensor data collection and artificial intelligence. The failure detection also includes a form of root cause analysis, which results in the most appropriate set of repair suggestions.

### Detection and Repair Mode

In Detection & Repair Mode, the system allows the maintainer to verify the best repair action offered, and then execute the repair. This mode prompts the maintainer for feedback following the repair to enhance the system's decision logic for future repairs. The Detection & Repair Mode leverages existing capabilities that resolve equipment failures, such as electrical power rerouting systems, auxiliary power units, redundant server migration, and other existing self-healing capabilities. This mode also utilizes the available control by wire operations to reset software configurations and server hardware.

### Detection and Predictive Maintenance

In Detection & Predictive Maintenance Mode, the A-STAR system automatically performs system repairs with minimal or no user interaction. The goal of this mode is to maintain an error-free system state so that the dispersed system will continue operating normally without interrupting the operator. In the Detection & Predictive Maintenance Mode, the user is notified of the error and the appropriate repair after the A-STAR has performed the repair action. This mode essentially automates the actions that the user would otherwise normally take to resolve the failure.

What is claimed is:

1. A system to automatically test and repair a complex, distributed target system including hardware and software, the automated test and repair system comprising:
a knowledge base memory storing information about the target system, including information about the network topology of the target system, system events and system faults;
one or more computer processors including specialized hardware and software implementing a system status module, a decision module, and a user interface module, all modules being in operative communication with the knowledge base memory;
a communications interface between the target system and system status module enabling the system status module to detect faults in the target system, determine the underlying cause or causes of a fault, and predict potential future faults in the target system based upon information stored in the knowledge base memory;
a decision module in operative communication with the system status module enabling the decision module to identify an appropriate response to a fault detected by the system status module, the response potentially including an automated repair of the fault depending upon the severity of the fault; and
a user interface module in operative communication with the decision module, the user interface module including a display presenting repair actions taken by the decision module.

2. The automated test and repair system of claim 1, wherein the user interface module further includes a repair action module enabling a user to input feedback regarding actions undertaken to test and repair the target system.

3. The automated test and repair system of claim 1, wherein the system status module is operative to automatically determine the inter-relationships and connectivity of components and subsystems within the target system.

4. The automated test and repair system of claim 1, wherein decisions made by the decision module are based on the current mission state of the target system.

5. The automated test and repair system of claim 1, wherein decisions made by the decision module are based on cost factors including likelihood of success and mission impact.

6. The automated test and repair system of claim 1, wherein repair actions can either be automatically performed or reported to a user for final decision and action.

7. The automated test and repair system of claim 1, wherein repair actions are communicated to the knowledge base memory and stored for use in predicting future repair actions associated with the target system.

8. The automated test and repair system of claim 1, further including a plurality of format converters operative to convert data into formats appropriate to the system status module, decision module, and user interface module.
